(19) United States
(12) Patent Application Publication
(10) Pub. No.: US 2020/0282359 A1
(43) Pub. Date: Sep. 10, 2020

(54) SYSTEM AND METHOD FOR MICROJET AND VIBRATION-ASSISTED FLUIDIZATION OF NANOPARTICLES

(71) Applicants: Jean Andino, Chandler, AZ (US); Keju An, Tempe, AZ (US)

(72) Inventors: Jean Andino, Chandler, AZ (US); Keju An, Tempe, AZ (US)

(73) Assignee: Arizona Board of Regents on behalf of Arizona State University, Scottsdale, AZ (US)

(21) Appl. No.: 16/812,584

(22) Filed: Mar. 9, 2020

Related U.S. Application Data
(60) Provisional application No. 62/815,653, filed on Mar. 8, 2019.

(51) Int. Cl. B01D 53/83; B01D 53/62; B01D 53/88

(52) U.S. Cl. CPC B01D 53/83; B01D 53/62; B01D 53/885; B01D 2257/504; B01D 2255/20707; B01D 2253/1124; B01D 2255/802

(57) ABSTRACT

A system for fluidizing particles includes a fluidization reactor having a base, a gas injection surface positioned at the base configured to inject a first gas into the fluidization reactor, and a gas outlet, a secondary gas injector comprising a nozzle, positioned in the fluidization reactor and configured to deliver a secondary flow of a second gas into the fluidization reactor, a vibration inducing device rigidly attached to the fluidization reactor and configured to induce a vibrational acceleration on the fluidization reactor, and a vibration isolating device rigidly attached to the fluidization reactor and a mounting surface, configured to isolate vibrational forces from the vibration inducing device from the mounting surface. A method of fluidizing particles is also described.

### CROSS-REFERENCE TO RELATED APPLICATIONS

This application claims priority to U.S. Provisional Patent Application No. 62/815,653, filed on Mar. 8, 2019, incorporated herein by reference in its entirety.

### BACKGROUND OF THE INVENTION

Gas-solid fluidization is beneficial for enhancing the availability of material surface area and minimizing the formation of large agglomerates. The minimization of agglomeration is particularly helpful when considering nanosized particles and the large interparticle forces (e.g. electrostatic and Van der Waals forces) that support agglomeration. However, the fluidization of nanosized particles is challenging and may result in exceptionally restricted bed expansion and large bubble formation when the minimum fluidization velocity is attained.

Fluidization is broadly used in many industries for dispersing nanosized particles in a gas phase, due to the enhanced availability of surface area per unit mass of nanoparticles as compared to larger particles. The presence of numerous nanosized particles leads to the formation of large agglomerates due to the large interparticle forces (e.g. electrostatic and Van der Waals forces). When using nanosized powders, particularly agglomerate bubbling fluidization (ABF) types of particles, fluidization may be impeded by exceptionally restricted bed expansion and large bubble formation when the minimum fluidization velocity is attained.

Quevedo et al. disclosed microjet assisted fluidization using agglomerate particulate fluidization (APF) and ABF type nanosized powders. (Quevedo et. al, Fluidization Enhancement of Agglomerates of Metal Oxide Nanopowders by Microjets. Aiche Journal 56 (2010) 1456-1468.) The quality of gas-solid fluidization of nanoparticles was greatly enhanced by adding a high-velocity jet produced by a micronozzle pointing vertically downward. Use of an APF type nanopowder expanded the bed by up to 50 times its original bed height, and difficult-to-fluidize agglomerate bubbling fluidization (ABF) type nanopowders exhibited behavior similar to the APF type, although with lower bed height expansion. U.S. Pat. No. 8,118,243 to Pfeffer et al., incorporated herein by reference in its entirety, used a microjet to enhance the fluidization of nanoparticles and agglomerates. The turbulent flow created by the microjet was advantageous for fluidizing the agglomerates and the shear generated by the microjet was effective in breaking apart the agglomerates. Wang, et al., (Simulations of vertical jet penetration using a filtered two-fluid model in a gas-solid fluidized bed. Particuology 31(2017) 95-104) investigated the flow behavior of gas and particles in a cylindrical fluidized bed for different jet velocities through a two-fluid model simulation.

Existing work related to the effect of vibration on particle fluidization includes Barletta et al. (The effect of mechanical vibration on gas fluidization of a fine aeratable powder. Chemical Engineering Research & Design 86 (2008) 359-369), which studied the fluidization behavior of a fine aeratable powder assisted by mechanical vibration in a reactor. The investigated parameters of vibration were the vibrational intensity (a/g=0.5, 1 and 2) and the frequency (between 7 and 200 Hz). As used herein, vibrational acceleration (a) is related to the sinusoidal displacement due to vibration and (g) is gravitational acceleration. The largest effects on bed expansion and differential pressure drops were found at low frequencies close to the natural frequency. Valverde et al. (Effect of vibration on agglomerate particulate fluidization. AIChE Journal 52 (2006) 1705-1714) studied fine and ultra-fine powders in centrifugal fluidized beds (CFB) and vibro-fluidized beds (VFB), and found that the quality of fluidization was improved with increased acceleration. Zhou et al. (Characteristic gas velocity and fluidization quality evaluation of vibrated dense medium fluidized bed for fine coal separation. Advanced Powder Technology 29 (2018) 985-995) adopted a vibrated dense medium fluidized bed (VDMFB) to remove noncombustible impurity minerals for fine coal separation. As the vibration frequency increased to a level close to the fluidized bed's natural frequency, the minimum fluidization gas velocity decreased significantly.

Numerous techniques have been employed to fluidize nanoparticles. Microjet assisted fluidization of agglomerate particulate fluidization (APF)- and agglomerate bubbling fluidization (ABF)-type nanosized powders has previously been disclosed as a particularly effective method. The addition of an alcohol vapor to a system that employs a photocatalyst such as TiO₂ (for example in Quevedo et al, above) significantly reduces the particle-to-particle and particle-to-reactor surface electrostatic charges, thereby improving fluidization quality. However, the alcohol limits the use of a TiO₂ nanoparticle fluidization system for environmental remediation work due to the alcohol's interactions and reactions on the surface. For example, alcohol may occupy TiO₂ surface sites and/or may react in the presence of TiO₂. Ethanol, for example, may react with OH radicals and eventually produce CO₂ and water vapor. In addition, current microjet systems require higher pressures through the nozzle.

One possible use of a nanoparticle fluidization system is in CO₂ capture and storage. CO₂ has been recognized as a major greenhouse gas among many other heat-trapping gases due to its relative abundance in the atmosphere. The US National Oceanic and Atmospheric Administration (NOAA) stated that global average concentrations of CO₂ surpassed 400 ppm in March 2015 for the first time since they started tracking carbon dioxide in the atmosphere. The human activity that pumped carbon dioxide into the atmosphere over the past 150 years raised its levels higher than during the industrial revolution, which began in around 1850, i.e. higher than 280 parts per million CO₂.

Carbon capture and storage (CCS) is a promising option for CO₂ reduction. Numerous methods to capture carbon dioxide have been proposed, including post-combustion carbon capture processes focusing on advanced solid adsorbents and fluidization/membrane systems. The use of a fluidized bed reactor is one of the promising techniques for CO₂ capture in a post-combustion process. The main benefits from fluidization are high gas-solids contact efficiency and the continuous regeneration of adsorbents. Li et al. studied CO₂ adsorption capacity over dry K₂CO₃/MgO/Al₂O₃ adsorbents in a fluidized bed reactor. (see Li, L., et al., CO₂ Capture over K2CO3/MgO/Al2O3 Dry Sorbent in a Fluidized Bed, Energy Fuels 25 (2011) 3835-3842, incorporated herein by reference). Other works utilized enhanced calcium-based adsorbents for CO₂ capture because calcium-oxide containing materials have high reactivity and adsorption capacity for CO₂ and low material cost. (see Li L., et al., MgAl₂O₄ spinel-stabilized calcium oxide absorbents with improved durability for high-temperature CO₂ capture. Energy Fuels 24 (2010) 3698-3703; and Lu, H., et al., Nanostructured Ca-based sorbents with high CO₂ uptake efficiency. Chem Eng Sci. 64 (2009) 1936-1943; both incorporated herein by reference). Still others mixed silica and calcium hydroxide powder to enhance the CO₂ adsorption efficiency in the fluidized bed. (see Valverde J M, et al., Improving the gas-solids contact efficiency in a fluidized bed of CO₂ adsorbent fine particles. Phys Chem Chem Phys. 13 (2011) 14906-14909, incorporated herein by reference).

There is a need in the art for a more effective method of fluidizing nanoparticles that allows for the fluidized product to be used in a wider variety of applications, including in CCS, as well as chemically sensitive scenarios as well as ones that naturally operate at lower pressures.

The present invention satisfies that need.

### SUMMARY OF THE INVENTION

In one aspect, a system for fluidizing particles, comprises a fluidization reactor having a base, a gas injection surface positioned at the base configured to inject a first gas into the fluidization reactor, and a gas outlet, a secondary gas injector comprising a nozzle, positioned in the fluidization reactor and configured to deliver a secondary flow of a second gas into the fluidization reactor, a vibration inducing device rigidly attached to the fluidization reactor and configured to induce a vibrational acceleration on the fluidization reactor, and a vibration isolating device rigidly attached to the fluidization reactor and a mounting surface, configured to isolate vibrational forces from the vibration inducing device from the mounting surface. In one embodiment, the system further comprises a controller connected to the vibration inducing device and configured to control at least one vibration parameter of the vibration device selected from the group consisting of vibration intensity, vibration frequency, and axis of displacement. In one embodiment, the system further comprises a mass flow controller fluidly connected between the source of first gas and the gas injection surface and communicatively connected to the controller, configured to control the flow of first gas into the gas injection surface. In one embodiment, the system further comprises a first pressure regulator fluidly connected to the gas injection surface, and a second pressure regulator fluidly connected to the secondary gas injector, wherein the first and second pressure regulators are communicatively connected to the controller.

In one embodiment, the system further comprises a fluid bubbler, fluidly connected between a source of first gas and the gas injection surface, wherein the first gas flows through the fluid bubbler, then through the gas injection surface into the fluidization reactor. In one embodiment, the first and second gases have the same composition. In one embodiment, the vibration inducing device is configured to vibrate at a frequency in a range of 40 to 70 Hz. In one embodiment, the system further comprises a differential pressure sensor having a first tap positioned near a top end of the fluidization reactor and a second tap positioned near the base of the fluidization reactor, configured to measure a differential pressure along a height of the fluidization reactor.

In one embodiment, the system further comprises a filter positioned at the exhaust of the fluidization reactor. In one embodiment, the fluidization reactor is configured to fluidize TiO2 particles. In one embodiment, the fluidization reactor is substantially cylindrical. In one embodiment, the secondary gas injector nozzle has an outlet diameter in a range of 200 to 500 μm. In one embodiment, the secondary gas injector nozzle is positioned about 10 cm above the base of the fluidization reactor. In one embodiment, the secondary gas injector nozzle is configured to inject the second gas in a direction substantially towards the base of the fluidization reactor. In one embodiment, the first gas comprises CO₂. In one embodiment, the system further comprises a quantity of TiO₂ particles positioned in the fluidization reactor.

In another aspect, a method of fluidizing a quantity of particles comprises the steps of positioning a quantity of particles in a fluidization reactor, inducing a vibrational force on the fluidization reactor, injecting a first gas into the fluidization reactor from a gas injection surface positioned at the base of the fluidization reactor, and injecting a second gas into the fluidization reactor from a secondary gas injector, wherein the quantity of particles fluidizes to a nondimensional height of at least 2. In one embodiment, the method further comprises waiting for a time period of at least one minute after inducing the vibrational force, before injecting the second gas into the fluidization reactor. In one embodiment, the method further comprises filtering the first gas or the second gas through a fluid bubbler prior to injection into the fluidization reactor. In one embodiment, the method further comprises controlling the mass flow of the first gas into the fluidization reactor with a mass flow controller.

In one embodiment, the method further comprises measuring a differential pressure between a first tap at a distance from the base of the fluidization reactor and a second tap near the base of the fluidization reactor. In one embodiment, the method further comprises flowing exhaust gas from an outlet of the fluidization reactor. In one embodiment, the method further comprises flowing the exhaust gas through a filter. In one embodiment, the filter is a HEPA filter. In one embodiment, the method further comprises passing the quantity of particles through a sieve prior to positioning the particles in the fluidization reactor in order to remove agglomerates. In one embodiment, the particles are TiO₂ particles. In one embodiment, the first gas is injected at a superficial gas velocity of between 0.005 m/s and 0.035 m/s. In one embodiment, the vibrational force is induced at a frequency between 40 Hz and 70 Hz. In one embodiment, the first gas and the second gas have the same composition. 30. In one embodiment, the first gas is selected from the group consisting of CO₂, N₂, O₂, CH₄, CO, NO, NO₂, and a volatile organic compound. In one embodiment, the second gas is selected from the group consisting of CO₂, N₂, O₂, CH₄, CO, NO, NO₂, and a volatile organic compound.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a schematic diagram of an exemplary particle fluidization system;

FIG. 2 is a diagram of a method of the present invention;

FIG. 3 is a graph of vibration amplitude over frequency;

FIG. 4 is a photograph of particles in a fluidization reactor;

FIG. 5A is a graph of non-dimensional height over vibration intensity;

FIG. 5B is a graph of non-dimensional height over vibration intensity;

FIG. 6 is a graph of non-dimensional height over vibration frequency;

FIG. 7A is a graph of non-dimensional height over gas velocity;

FIG. 7B is a graph of non-dimensional height over gas velocity;

FIG. 8 is a graph of non-dimensional height over gas velocity;

FIG. 9 is a graph of non-dimensional height over time;

FIG. 10A and FIG. 10B are graphs of non-dimensional height across vibration intensity and the gas velocity in m/s;

FIG. 11A and FIG. 11B are error graphs related to FIG. 10A and FIG. 10B;

FIG. 12A is a graph of non-dimensional pressure drop over gas velocity;

FIG. 12B is a graph of non-dimensional pressure drop over gas velocity;

FIG. 13A and FIG. 13B are diagrams of the forces and differences in bed heights for an MVA and VFB system;

FIG. 14 is a schematic diagram of an exemplary CCS system;

FIG. 15 is a graph of the ratio of outlet CO₂ concentration to inlet CO₂ concentration over time;

FIG. 16 is a graph of CO₂ adsorption capacity of a VFB versus an MVA system;

FIG. 17 is a set of diagrams of various particle fluidization systems; and

FIG. 18 is a table showing the comparative results of various fluidization methods; and

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Throughout this disclosure, various exemplary embodiments of a system or method may be described as operating with a particular particle type, for example a P25 or P90 TiO₂ nanoparticle powder. It is to be understood that such examples are not meant to be limiting, and that the systems and methods described herein may be used with any suitable particle of any suitable size known in the art, including but not limited to Cu—TiO₂, I—TiO₂, Cu—I—TiO₂, Zinc Oxide, or Tin Oxide. Suitable particles may for example include any catalyst. The terms “particle”, “powder”, “nanopowder”, “nanoparticle” and “nanoparticle powder” are used interchangeably herein.

### System Configuration

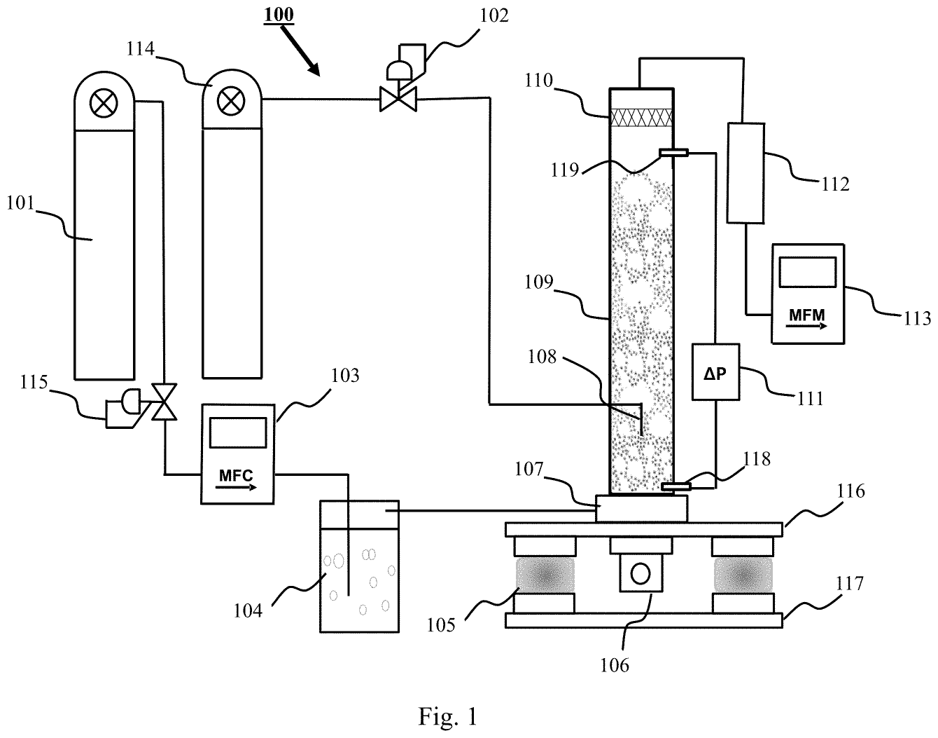

Embodiments of a system of the present invention may be better understood with reference to FIG. 1, in which a diagram of exemplary system 100 is shown. System 100 includes a fluidization reactor 109, which may be a columnar reactor with an inner diameter of 76 mm and a height of 800 mm made of clear cast acrylic. Although specific dimensions and materials are recited, it is understood that a variety of suitable reactors of different shapes and sizes may be used in various embodiments of a system of the present invention, including columnar reactors with inner diameter in a range from 3 to 5 inches and height in a range of 800 mm to 1000 mm. For example depending on the type of particle, reactors of different shapes including shapes with an ovular or a square cross-section, and made from alternative materials including but not limited to UV transparent plastics, steel, or thick-walled glass may be used.

A gas distributor 107 positioned at the base of the fluidization reactor 109 may supply a first gas, for example nitrogen gas or air at a superficial velocity in a range from 0.005 to 0.035 m/s. One exemplary gas distributor comprises a sintered quartz plate, 2 mm thick and having a pore size of 20 microns, but it is understood that other gas distributors may be used, for example but not limited to a porous steel plate. Nitrogen may be supplied from compressed gas cylinder 101 and may be humidified, for example by flowing through a bubbler 104 containing water or another fluid, fluidly connected to the bottom of the fluidization reactor 109 through gas distributor 107. The gas flow from gas cylinder 101 may be regulated for example by a pressure regulator 115 and/or a mass flow controller 103. Mass flow controller 103 may be adjustable, for example between 0 and 15 L/min in order to control the rate at which the gas from compressed gas cylinder 101 flows into fluidization reactor 109 to mix with the particles loaded in the reactor.

In one exemplary embodiment nanosized titanium dioxide (TiO₂), a photocatalyst of ABF type, was selected for use as a nanopowder due to its usefulness in air pollution control applications. Photocatalytic TiO₂ surfaces are activated for chemical reactions when light of a sufficient energy reaches the surface, and when the compounds of interest are able to selectively adsorb to the surface through the availability of more surface area (on a per mass basis) with smaller sized particles. Compounds of interest may include, but are not limited to, CO, CO₂, volatile organic compounds, NO, NO₂, H₂S, and SO₂. Both of the useful particle properties in use as a photocatalyst in air purification (exposed surface area and number of particles exposed to light) can potentially be enhanced through the fluidization of nanoparticles. Through the use of the methods and systems disclosed herein, measurable improvements were observed in agglomeration, nondimensional bed height, nondimensional pressure drop, and minimum fluidization velocity.

System 100 may include a device for measuring the pressure drop, for example using a differential pressure manometer 111 between two taps 118 and 119, one at or near the top of the column (119) and the other located above the gas distributor (118). In one embodiment, the bottom tap 118 is located 2 cm above the gas distributor 107. The fluidization reactor 109 may be mounted on a plate or other device 116. The plate may be mounted to a table or other flat surface 117 for example using a plurality of vibration isolators or springs 105 to isolate the vibrational motion of the fluidization reactor from external forces. In other embodiments, the fluidization reactor may be rigidly mounted to a table, and the table may be mounted to the floor using a plurality of springs to isolate vibrational motion. The fluidization reactor may then be mounted to a vibration inducing device 106, for example an electromagnetic vibrator. Electromagnetic vibration may be controlled for example by a signal generator, which provides vertical sinusoidal motions with controlled amplitude and frequency. In some embodiments, a vibration inducing device of in a system of the present invention may be controlled by an integrated controller or by a computing device. Suitable vibration frequency ranges include a range from 40 to 70 Hz, or in some embodiments with an optimum resonance frequency near 50 Hz given the configuration of the system that was specified previously. The electromagnetic vibrator may be configured to deliver vibrational force in an axis substantially parallel to the height of the fluidization reactor 109 (i.e. vertical), perpendicular to the height of the fluidization reactor 109 (i.e. horizontal), or a combination of the two axes. In some embodiments, the axis of vibration may vary randomly or be controllable. Vibrational amplitude may be monitored for example using a vibration meter coupled to the bed or to a table or platform on which the bed rests.

In some embodiments, a system of the present invention includes a secondary injection nozzle 108 for injecting a gas from compressed gas cylinder 114 into the fluidization reactor 109, for example a downward pointing nozzle positioned at a fixed or variable distance above the base of the fluidization reactor. In some embodiments, the nozzle 108 may include a removable nozzle tip (not shown) which may be removably attached to the nozzle via screw threads or some other mechanical locking mechanism. In some embodiments, a system of the present invention includes multiple nozzles positioned substantially coplanar, or at different heights above the base of the fluidization reactor. In some embodiments, multiple downward micronozzles may be applied to a larger, pilot scale reactor to obtain a sufficient level of fluidization. In some embodiments, the multiple nozzles may inject gas at different flow rates, while in other embodiments two or more or all of the nozzles inject gas at substantially the same flow rate. In one embodiment, a system includes multiple nozzles positioned in a coplanar pattern at a height above the base of the fluidization reactor. In one embodiment, a downward pointing nozzle or micronozzle 108 is positioned at a height of 10 cm above the distributor 107. A nozzle or micronozzle may be connected to a pressure regulator 102 in order to generate a secondary flow.

In some embodiments, pressure regulators 102 and 115 may be configured to work together to produce a predetermined absolute pressure ratio (P_{down}/Pᵤₚ), where P_{down} is the downstream pressure and Pᵤₚ is the upstream pressure. In the example of FIG. 1, Pᵤₚ is the pressure measured at tap 118 of manometer 111, and P_{down} is the pressure measured at tap 119. In one embodiment, a system may be configured to approach a critical pressure ratio, for example 0.52. A nozzle or micronozzle may have an outlet diameter of 500 microns (μm) or in a range of 400-600 μm, or 200-500 μm. A nozzle outlet may have a substantially round shape. In one embodiment, a secondary flow is delivered at 10 psi (68.9 kPa) gage, but in other embodiments, other secondary flow pressures may be used, for example between 1 psig and 20 psig.

At the outlet of the fluidization reactor, gases may first be passed through prefilter 110, then through filter 112, which may be for example a HEPA filter. The HEPA filter may be configured to trap any elutriated nanoparticles. Mass flow meter 113 may be used to control the flow rate of gas out from the system.

In some embodiments, an MVA system as disclosed herein may be used for CCS. This may be accomplished by using a sorbent material directed to capture CO₂, such as nanoparticles of zeolites, activated carbon, or sodium hydroxide, or encapsulated sorbents. Additional information regarding CO₂ capture using zeolites, activated carbon, sodium hydroxide, and other encapsulated materials may be found in the following publications, all of which are incorporated herein by reference. R. Girimonte, et al., Adsorption of CO₂ on a confined fluidized bed of pelletized 13X zeolite, Powder Technology 311 (2017) 9-17; F. Raganati, et al., CO₂ adsorption on fine activated carbon in a sound assisted fluidized bed: effect of sound intensity and frequency, CO₂ partial pressure and fluidization velocity, Appl. Energy 113 (2014) 1269-1282; Sareh Naeem, et al., Experimental investigation of CO₂ capture using sodium hydroxide particles in a fluidized bed. Korean Journal of Chemical Engineering (2016) 33 (4); J. J. Vericella, R. D. Aines, Encapsulated liquid sorbents for carbon dioxide capture, Nature Communications 6:6124 (2015) DOI: 10.1038.

CO₂ may be introduced to the system for example via the distributor 107, and/or in some embodiments the gas channel to microjets 108 may comprise CO₂. In various embodiments, CO₂ may be introduced to the MVA in any suitable volumetric concentration, for example 1%, 2%, 5%, 10%, 20%, 50%, or 100% CO₂. The remaining non-CO2 gas introduced to the system may in various embodiments comprise N₂, O₂, CH₄, CO, NO, NO₂, volatile organic compounds (VOCs), or any other suitable carrier/mixing gas. In some embodiments, an MVA system may include a mixture of multiple different particles, each of which is selected to capture one or more pollutants described herein, in addition to CO₂ capture. In some embodiments, CO₂ is introduced mixed in with air. In some embodiments, CO₂ is introduced to the system from the outlet of a smokestack or other system exhaust.

In various embodiments, a system may comprise multiple passes of a CO₂-containing gas mixture introduced to one or more MVA beds. For example, in one embodiment, a gas mix having a high concentration of CO₂ may be introduced through distributor 107. After the adsorbent material removes some CO₂ from the gas mix, the exhaust gas from outlet, for example the outlet of filter 112, may be collected for reintroduction to the distributor 107, at which point the CO₂ concentration may be reduced further. In other embodiments, multiple MVA beds may be arranged in series, with the outlet of a first MVA bed fluidly connected to the inlet of the next MVA bed, and so on. Various embodiments may include one, two, three, five, 10, 20, or 50 MVA beds arranged in series. The number of MVA beds may vary based on the application process.

Although such a system itself requires additional energy to operate, and energy generation typically produces CO₂, it is understood that in some embodiments a system of the invention may be powered by low-emitting or renewable energy sources such as solar, wind, geothermal, tidal, or other suitable sources of energy in order to produce a net carbon dioxide reduction through operation.

### Methods of the Invention

In certain embodiments, a preparation step includes determining the resonant and anti-resonant frequencies for the system since these are critical parameters for vibrating systems. The resonant and anti-resonant frequencies may then be used to alter or select particular vibration frequencies for use in fluidization. In some embodiments, a vibration system may be activated prior to activating a secondary gas injector or microjet, in order to reduce the formation of bubbles and channels in the powder. In some embodiments, a vibration system may be activated at a first intensity and/or frequency prior to activating a microjet, then change to a second intensity and/or frequency after activating the microjet. In one embodiment, an absolute pressure ratio is periodically calculated and recorded, and the changing value of the absolute pressure ratio may be used by a controller to vary other parameters of a system of the present invention, including but not limited to vibration intensity, vibration frequency, vibration axis of displacement, or gas flow rate. In some embodiments, the controller may further measure a variety of other parameters, including but not limited to bed height, exhaust gas flow, or actual vibration frequency.

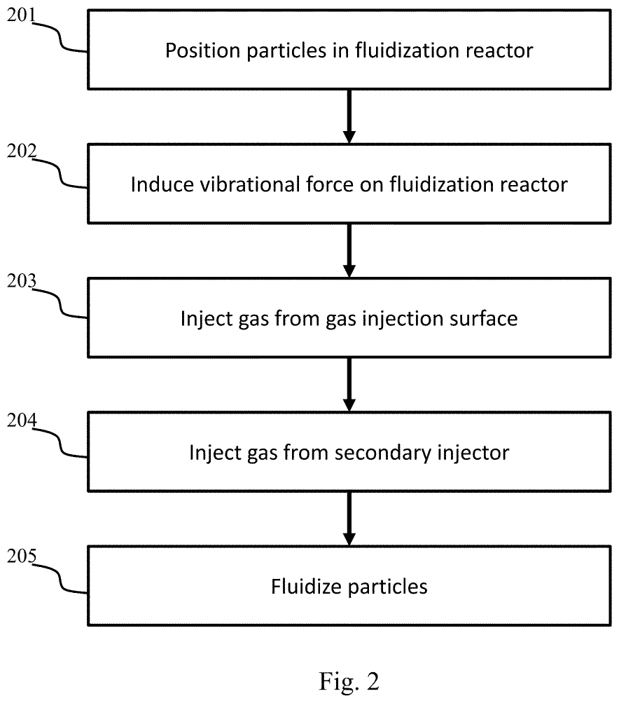

Referring now to FIG. 2, an exemplary method of fluidizing particles is shown. The method includes step 201 of positioning a quantity of particles in a fluidization reactor, step 202 of inducing a vibrational force on the fluidization reactor, step 203 of injecting a first gas into the fluidization reactor from a gas injection surface positioned at the base of the fluidization reactor, step 204 of injecting a second gas into the fluidization reactor from a secondary gas injector; and step 205 of fluidizing the particles.

In some embodiments, there may be a delay between step 202 and step 203, for example of a minute or more, in order to reduce the incidence of channel formation. In some embodiments, the secondary gas injector may remain active for the duration of the fluidization, while in other embodiments, the secondary gas injector may be active during the beginning of the fluidization, then turned off later in the fluidization. In some embodiments, the secondary gas injector may be activated in a periodic or substantially periodic manner. The vibrational force may in some embodiments be enough to stabilize the bed at a higher height after the secondary gas injector is turned off.

In some embodiments, the first gas or the second gas may be passed through a fluid bubbler or a mass flow controller prior to entering the fluidization reactor. In some embodiments, a method may comprise measuring a differential pressure between a first tap and a second tap, positioned at a distance from the base of the fluidization reactor and close to the base of the fluidization reactor, respectively. In some embodiments, a method may comprise flowing the exhaust gas from an outlet of the fluidization reactor, and through one or more filters, for example a HEPA filter. In some embodiments, the first gas may be injected from the gas injection surface in step 203 at a superficial gas velocity of between 0.005 m/s and 0.035 m/s. In some embodiments, the vibrational force of step 202 is induced at a frequency of between 40 Hz and 70 Hz. In some embodiments, the first and second gases may have the same composition.

Particles for use in a system or method of the present invention may include for example commercial ABF type nanopowders, such as TiO₂ P25, manufactured by Evonik-Degussa. Although the experiments outlined below were performed with TiO₂ particles, it is understood that systems and methods of the present invention may be used with a wide variety of different particles, including but not limited to Cu—TiO₂, I—TiO₂, Cu—I—TiO₂, Zinc Oxide, or Tin Oxide, or any catalyst. Nanopowders for use in a method or system of the present invention may first be sieved using a 500 μm sieve placed on a vibration shaker, in order to remove large agglomerates that may have been gradually enlarged during packing, storage, and transportation. The properties of the TiO₂ P25 that were used are shown in Table 1.

TABLE 1

| | Fluidization | | Primary Particle | Surface | Tap density, |
|---|---|---|---|---|---|
| Type | Behavior | Material | Size, [nm] | Area, [m²/g] | [kg/m³] |
| TiO₂ P25 | ABF | TiO₂ | 21 | 50 | 130 |

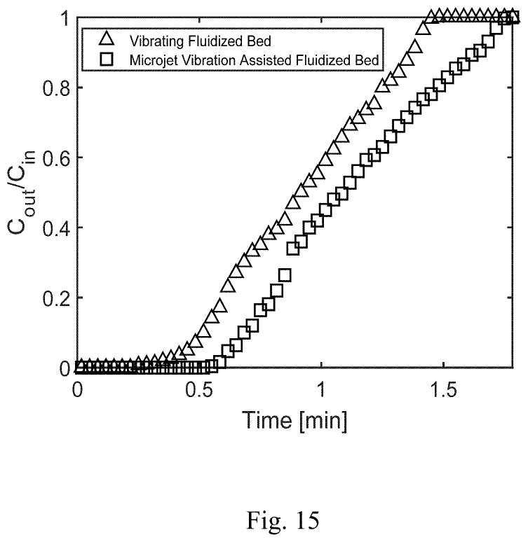

The present disclosure additionally includes methods for CCS, including but not limited to introducing an intake gas comprising CO₂ at an input concentration to a fluidization reactor, via a distributor inlet or a microjet inlet or both. The outlet gas, having interacted with a quantity of adsorbent nanoparticles in the fluidization reactor, will then have a lower concentration of CO₂ than the input concentration. The nature of the nanoparticles that are used, as well as the composition of the mixed gas may be varied to dictate the percent reduction in the inlet CO₂ levels in a given timeframe. In one exemplary embodiment, a 1% CO₂ in N₂ mixture was introduced to an MVA which included TiO₂ nanoparticles, and a complete (i.e. 100%) reduction of the CO₂ concentration was achieved. Experimental data related to this exemplary embodiment may be found in FIG. 15.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Fluidization Test—Setup

Two agglomerate bubbling fluidization (ABF) type nanopowders were used: TiO₂ P25 and TiO₂ P90, manufactured by Evonik-Degussa. Before all experiments, the nanopowder was sieved using a 500 μm sieve placed on a vibration shaker, in order to remove large agglomerates that may have formed during storage. The properties of TiO₂ P25 and P90 nanopowders are shown in Table 2 below.

TABLE 2

| | Brand/ | Particle Size | Surface Area | Tap Density |
|---|---|---|---|---|
| Material | Manufacturer | [nm] | [m²/g] | [kg/m³] |
| TiO₂ P25 | Aeroxide/Evonik- | 21 | 50 | 130 |
| | Degussa | | | |
| TiO₂ P90 | Aeroxide/Evonik- | 14 | 90 | 120 |
| | Degussa | | | |

The experiments were performed in a column reactor with an inner diameter of 76 mm and a height of 800 mm made of clear cast acrylic. Nanosized powders were fluidized with high purity nitrogen at a superficial gas velocity range from 0.005 to 0.035 m/s, supplied to the fluidized bed through a gas distributor at the bottom, consisting of a sintered quartz plate 2 mm thick having a pore size of 20 μm. The nitrogen from the compressed gas cylinder was humidified by being passed through a water bubbler that connected to the bottom of the column. The exhaust gas from the bed was filtered through a HEPA filter to trap any elutriated nanoparticles. The pressure drop was measured using a differential pressure manometer (RISEPRO HT-1890) between two taps, one at the top of the column and the other located 2 cm above the gas distributor. The transparent bed reactor was mounted on a custom-made wooden plate with four springs attached to it in order to isolate the vibrational motion from the lab bench surface and the ground. An electromagnetic vibrator was mounted below the wooden plate that supported the transparent bed reactor. Electromagnetic vibration was controlled by a signal generator (Cleveland Vibrator Co. VAF-3) which provided vertical sinusoidal motions with controlled amplitude and frequency. The frequency range that was used was from 40 to 70 Hz, and the amplitude was monitored using a vibration meter (PCE Instruments #PCE-VT 2700) that was attached to the table. Initial experiments were conducted to determine the resonant and anti-resonant frequencies for the system since these are critical parameters for vibrating systems. The downward pointing nozzle was placed at a height of 10 cm above the distributor since this placement previously showed enhanced fluidization performance in a system with identical dimensions. The micronozzle was connected to a pressure regulator that was used to generate the secondary flow. The nozzle diameter used in this work was 500 μm, which is identical to the nozzle size used by Quevedo et al. The overall schematic of the experimental setup is shown in FIG. 1.

Dry nitrogen was supplied from a compressed gas cylinder and subsequently humidified by passing the nitrogen through a water bubbler. A mass flow controller (MFC) was used to control the gas flow rate at the bottom distributor, as shown in FIG. 1. The mass flow controller had a range from 0 to 15 L/min to enable adjustment of the superficial gas velocity through the reactor. Two pressure regulators were used to produce flow through the micronozzle at 5 psig and gas flow through the mass flow controller. The absolute pressure ratio (P_{downstream}/Pᵤₚₛₜᵣₑₐₘ) across the micronozzle in the MVA system was 0.746, different than the critical pressure ratio of 0.52 which is required to achieve choked, sonic flow.

A comparative analysis was performed between simple microjet assisted (MA) fluidization, in addition to a vibro-fluidized bed (VFB) in the absence of an alcohol. The results were also compared to the results reported in Quevedo et al., which used a microjet as a secondary flow to the superficial flow with a dilute alcohol solution to break-up large agglomerates, prevent channeling, bubbling, and promote liquid-like fluidization. The experiments described below using a combined microjet and vibration assisted (MVA) fluidization in the absence of an alcohol solution were compared with simple MA and VFB fluidization in the absence of an alcohol as well as the previously published results of MA with an alcohol support.

The experiments were performed under a variety of different conditions. A single-axis vertical magnetic vibrator was used. First, the vibrational frequency was varied between 40 Hz to 70 Hz, the vibrational intensity was varied between 1 and 2, and the superficial gas velocity (0.02 m/s) was held constant. The MVA system's nondimensional height versus vibrational frequency (40 to 70 Hz) was recorded for both powders with two different superficial gas velocities (U_{g}) of 0.01 and 0.02 m/s.

In a second iteration, the experiments were performed while varying the superficial gas velocity in a range of 0.005 to 0.035 m/s, and maintaining a constant vibrational intensity and frequency using vibration parameters determined in the first set of experiments, to evaluate the effect of the superficial velocity on the fluidized bed. Thirdly, three dimensional plots were created to show the synergistic effects of the vibrational intensity and superficial gas velocity on bed expansion. Lastly, the nondimensional pressure drop was examined as a function of superficial gas velocity to determine the minimum fluidization velocity for both the VFB and MVA systems. The characteristics of fluidization were investigated by increasing the superficial gas velocity in small steps (0.1 cm/s), starting from 0.005 m/s. The vibrational intensity range was determined by the vibratory system's frequency and amplitude range based on its operating conditions. For the MVA system, the fluidized bed height expansion ratio (the nondimensional height) and the bed pressure drop were recorded while the vibrator was turned on. In all cases where MVA fluidization was employed, the vibrator was turned on before the microjet in order to avoid large bubble and channel formation. The fluidized bed behavior as well as the pressure drop value stabilized after 1 to 2 minutes. The minimum fluidization velocity (U_{mf}) was determined by a plot of nondimensional pressure drop against the gas velocity. The operating conditions of all fluidization experiments are shown in Table 3.

TABLE 3
Experimental Conditions

| | |
|---|---|
| Powder Mass [g] | 50 |
| Vibrational Frequency [Hz] | 40, 50, 60, 70 |
| Vibrational Intensity | 1, 1.2, 1.4, 1.6, 1.8, 2.0 |
| Gas velocity [m/s] | 0.005 to 0.035 |

The range of frequencies were selected based on establishing a range around the resonant and anti-resonant frequencies of the system. The vibrational intensity range was obtained by using the system's amplitude level coupled with each frequency level. (The mathematical relationship is presented subsequently in this disclosure.)

### Fluidization Test—Results and Discussion

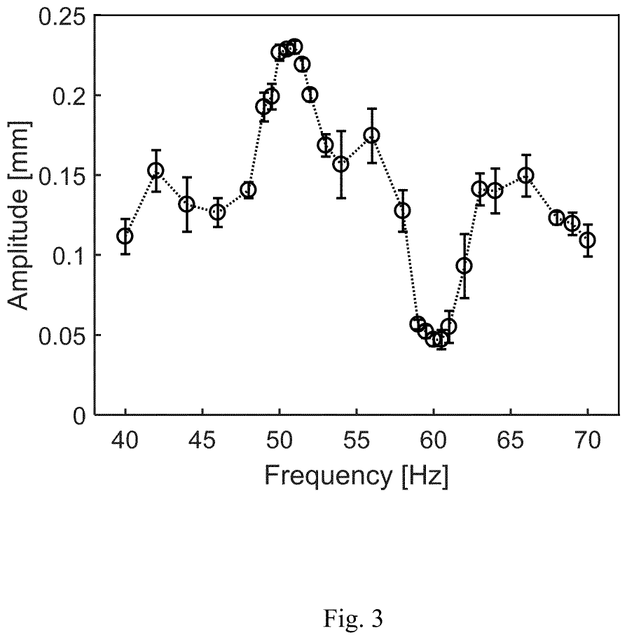

The relationship between amplitude and vibrational frequency for the system was investigated and the results are shown in FIG. 3. The data suggest that the resonant and antiresonant frequencies are, respectively, 50 and 60 Hz.

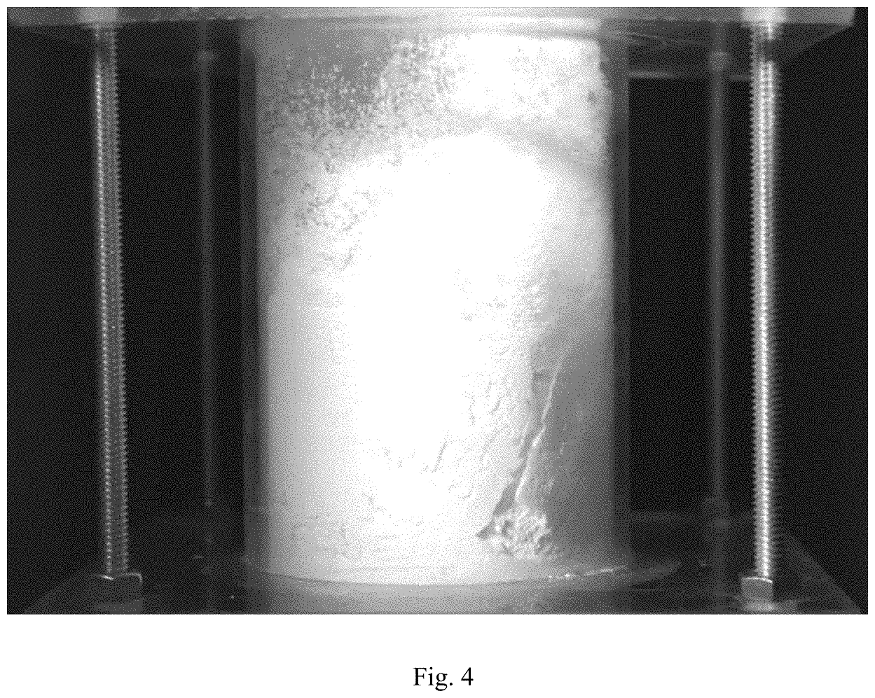

Baseline background studies using only a microjet in the absence of an alcohol to minimize electro-static effects resulted in poor fluidization. As seen in FIG. 4, using only microjet assistance to fluidize the TiO₂ P25 particles in the absence of an alcohol, under non-choked flow conditions, led to severe channeling and powder fluctuation problems. The results shown in FIG. 4 demonstrate the need for additional fluidization assistance methods for TiO₂ nanosized powders.

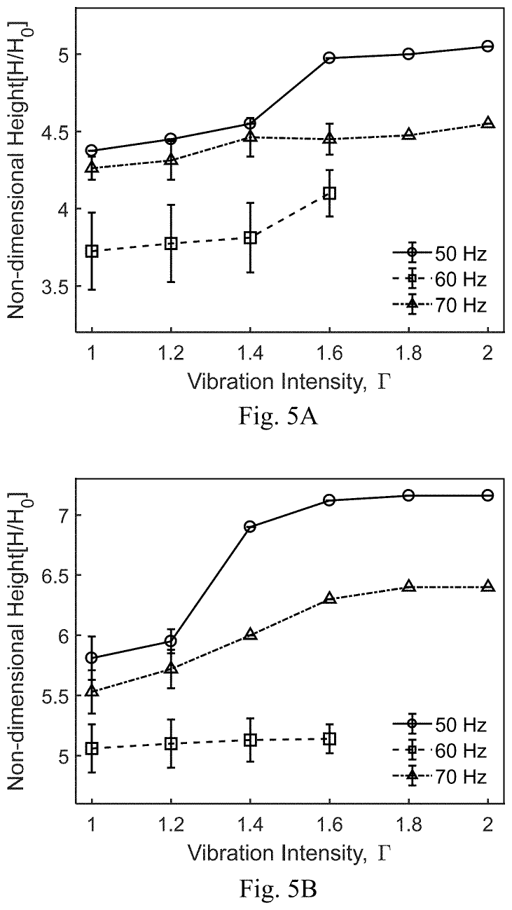

The experimental results of the MVA fluidized bed that appear in FIG. 5A and FIG. 5B show nondimensional height (H_{nd}) of the fluidized bed on the y-axis and vibration intensity range of 1 to 2 measured at fixed frequencies of 50, 60 and 70 Hz on the x-axis. H_{nd} was obtained by dividing the stable fluidized bed height by the initial packed bed height when the sieved TiO₂ powder had been just loaded, and is described by Equation 1:

$${H}_{n d} = \frac{H}{{H}_{0}} \qquad Equation 1$$

where H is the height of the stable fluidized bed and Ho is the height of the initial packed bed of powder. FIG. 5A shows the results for the P25 particles, while FIG. 5B shows the results for P90 particles. Multiple readings were taken for each experimental condition at each bed height to confirm the measurements, and error bars (FIG. 5A and FIG. 5B) represent the overall distribution of the data. The vibration intensity (Γ) is defined as the ratio of vibrational acceleration to gravitational acceleration, and can be described mathematically by Equation 2:

$$Γ = \frac{{A ( 2 π f )}^{2}}{g} \qquad Equation 2$$

where A is the amplitude of vibration (varied from 0.05 to 0.3 mm), as adjusted and measured by the vibration meter, f is the vibration frequency in Hz, and g is gravitational acceleration, 9.8 m/s².

As shown in FIG. 5A and FIG. 5B, H_{nd} was the largest with a vibration frequency of 50 Hz, the resonant frequency for both TiO₂ P25 and TiO₂ P90 powders in the custom-designed system that was used. For the TiO₂ P25 powder, H_{nd} increased up to a stable value of 5 when the vibration intensity was 1.6 (see FIG. 5A). H_{nd} for both TiO₂ P25 and P90 were the smallest at a vibration frequency of 60 Hz with all intensity ranges that were tested. This is consistent with the observation that 60 Hz is the antiresonance frequency. H decreased as vibration frequency increased from 50 to 70 Hz, but a frequency 60 Hz showed a lower H_{nd} result as compared to the H_{nd} at 70 Hz. Nevertheless, the depicted measurements show that, for TiO₂ powders, vibration with adjusted frequency and amplitude improves the fluidization quality (as measured by H_{nd}) by supporting the gas flow to overcome interparticle forces and break up channels.

It is important to note that only limited data at a vibrational frequency of 60 Hz were acquired because H_{nd} was exceptionally small, due to the fact that 60 Hz was observed to be the antiresonance frequency of the system as shown in FIG. 3.

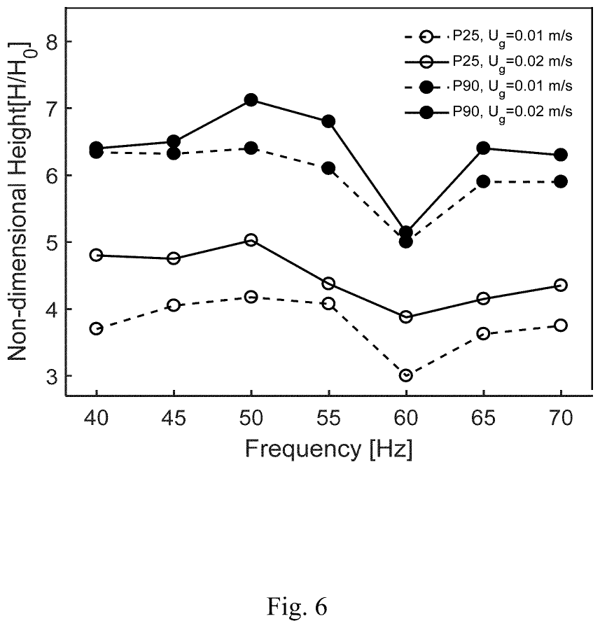

FIG. 6 shows H_{nd} on the y-axis and vibrational frequency from 40 to 70 Hz on the x-axis for both powders, TiO₂ P25 and P90 at superficial gas velocities (U_{g}) of 0.01 and 0.02 m/s. A higher H_{nd} was observed for TiO₂ P90 as compared to P25. As can be seen from this figure, the maximum H_{nd} can be found at a frequency of 50 Hz and a gas velocity of 0.02 m/s.

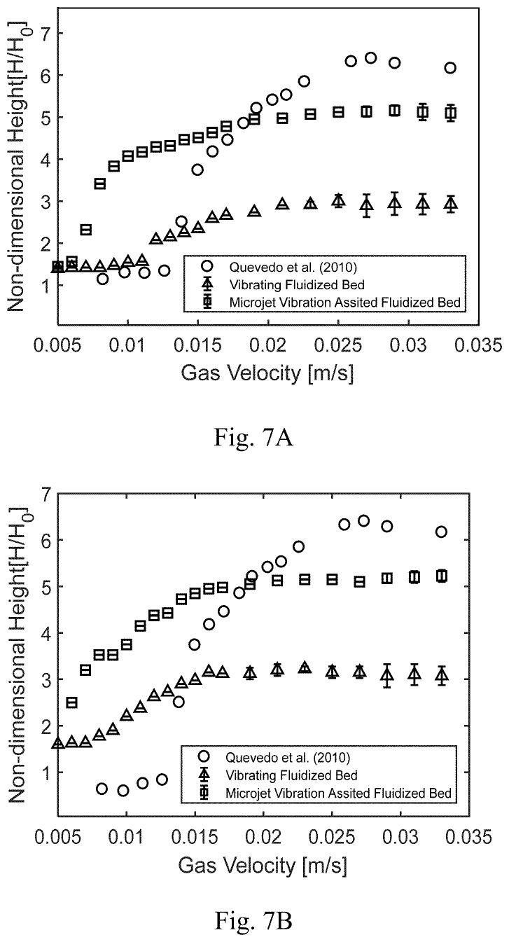

Direct comparisons of different methods are shown in FIG. 7A and FIG. 7B. In FIG. 7A, the superficial gas velocity was increased under a fixed vibrational frequency of 50 Hz and vibration intensity of 1.6. H_{nd} of TiO₂ P25 increased and then stabilized using all the various methods. The maximum bed expansion of the MVA fluidized TiO₂ P25 was approximately 5 times the initial bed height. The MVA fluidized bed height did not expand further and the bed height remained constant when the superficial gas velocity reached 0.017 m/s. It is important to note that H_{nd} for TiO₂ P25 in the MVA fluidized bed system was similar to previously published H_{nd} that was obtained in a similar system that used microjet assisted (MA) fluidization but employed an alcohol solution (Quevedo et al.). The systems and methods disclosed herein are a significant improvement over existing methods, particularly for photocatalytic air purification, because a chemical was not required to achieve similar bed expansion results that would be beneficial for gas-surface reactions. Also, it was observed that vibration assisted fluidization (VFB) alone resulted in only a bed expansion of 3 times the initial TiO₂ P25 bed height. The VFB system further showed some fluctuation at the top of the bed when the gas velocity was greater than 0.023 m/s. Thus, the VFB system was less efficient in fluidizing nanopowders than the MVA system disclosed herein.

Similarly, in FIG. 7B, the superficial gas velocity was increased with a fixed frequency of 50 Hz and a vibration intensity of 2. In the results of FIG. 7B, the nondimensional height increased and then reached a plateau for both the vibro-fluidized bed (VFB) and MVA fluidized bed. The VFB system only showed a bed expansion of 3 times the initial bed height, and fluctuation was observed at the top of the bed when gas velocity was more than 0.025 m/s. The maximum bed expansion of the MVA fluidized P25 TiO₂ was approximately 5 times the initial bed height. The MVA fluidized bed height did not expand further and the bed height remained constant when the superficial gas velocity reached 0.02 m/s. FIG. 7B also shows the MVA fluidized bed's nondimensional height as similar to the Quevedo et al. microjet assisted fluidized bed that employed an alcohol solution.

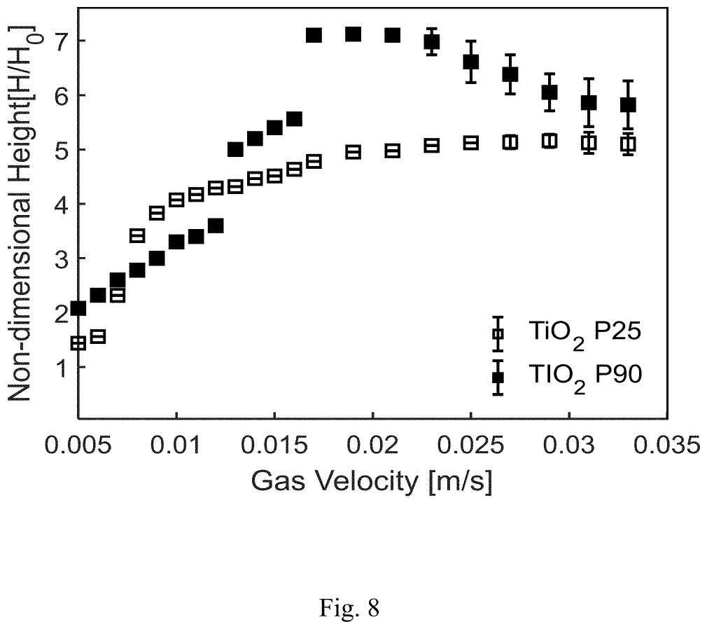

FIG. 8 shows the comparison of H_{nd} as a function of superficial gas velocity for TiO₂ P25 and TiO₂ P90 nanopowders in the MVA system. The H_{nd} obtained using TiO₂ P90 (H_{nd} of 7) is higher than that obtained using TiO₂ P25 (H_{nd} of 5) at about gas velocity 0.02 m/s because of the smaller density and primary particle size of TiO₂ P90 as compared to TiO₂ P25. However, the H_{nd} of the TiO₂ P90 bed decreased after a gas velocity of 0.023 m/s, and a large fluctuation was observed at the top of the fluidized bed.

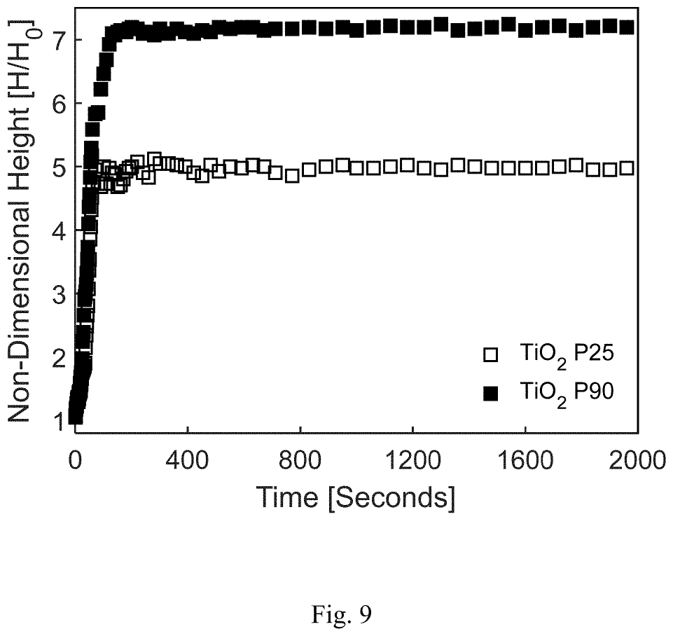

In order to employ fluidization as a tool in environmental remediation efforts, a fluidization system must be stable over time. FIG. 9 shows the MVA system's H_{nd} as a function of the fluidization time. The fluidized bed heights increased up to maximum after a short time for both TiO₂ nanopowders and remained constant for the entire testing time of 2000 seconds (33.3 minutes). This experimental result indicates that the MVA system disclosed herein has the potential to be applied to systems that are needed for continuous air purification processes.

### Synergistic Effect of Vibration and Superficial Gas Velocity

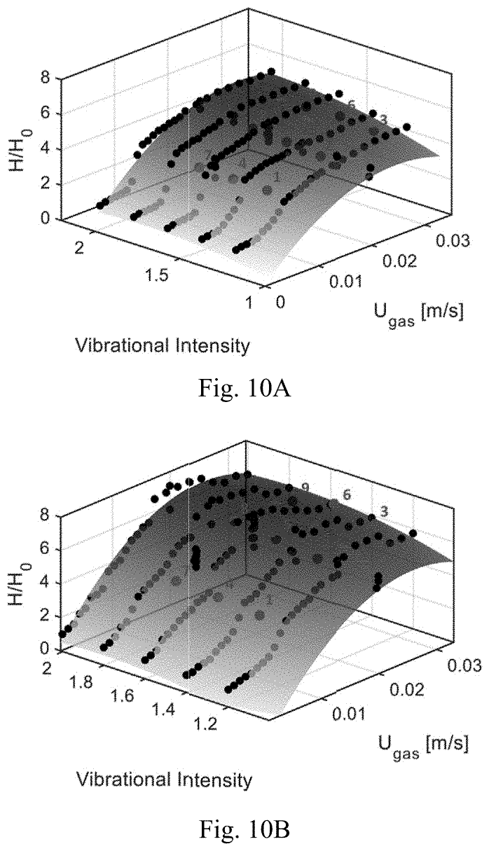

A 3-Dimensional surface fit (2nd order polynomial) has been proposed to describe the synergistic effect of the vibrational intensity and superficial gas velocity on the nondimensional height of the fluidized bed, as shown in FIG. 10A and FIG. 10B. A total of 155 experimental data points at different conditions were obtained and fit using Equation 3 below, with the coefficient values of the fitting curve shown in Table 4 below. Higher order polynomial fits were also investigated but did not adequately reproduce the data trends nor the physical operation of the system. Specifically, higher order fits predicted sharp increases in the non-dimensional height at high velocities and superficial gas velocities. Experimental data show a plateauing of the height. Thus, the actual physical phenomena are well represented by a two parameter 2nd order polynomial fit.

H_{nd}(U_{g},Γ)=p₀₀+p₁₀U_{g}+p₀₁Γ+p₂₀U_{g}²+p₁₁U_{g}Γ+p₀₂Γ² Equation 3

where p₀₀, p₁₀, p₀₁, p₂₀, p₁₁, and p₀₂ are the fitted coefficient values of the curve shown in Table 4, H_{nd} is the non-dimensional height of the fluidized bed, U_{g} is the superficial gas velocity in m/s, and Γ is the vibrational intensity. The numbers in parentheses in Table 4 represent the lower and upper 95% confidence bounds for the coefficients.

TABLE 4

| Coefficients | TiO₂ P25 | | TiO₂ P90 | |
|---|---|---|---|---|
| p₀₀ | −3.478 | (−5.664, −1.293) | −7.562 | (−11.09, −4.034) |
| p₁₀ | 297.2 | (248.1, 346.3) | 527.3 | (448.1, 606.6) |
| p₀₁ | 4.852 | (2.171, 7.534) | 8.482 | (4.153, 12.81) |
| p₂₀ | −6676 | (−7477, −5875) | −1.01 × 104 | (−1.138 × 10⁴, −8799) |
| p₁₁ | 30.65 | (4.557, 56.74) | −5.29 | (−47.4, 36.82) |
| p₀₂ | −1.411 | (−2.237, 0.5842) | −2.35 | (−3.684, −1.016) |

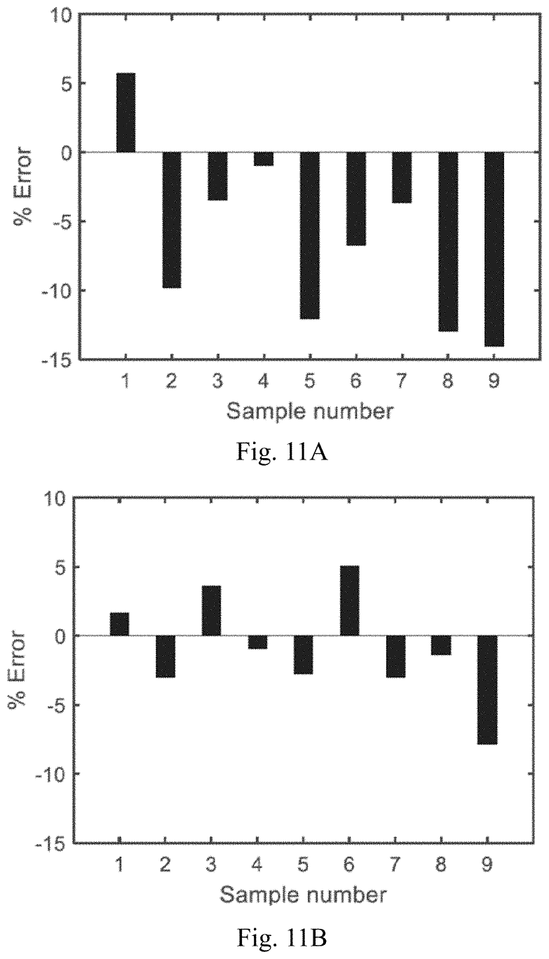

The mechanical vibration and microjet assistance imposed on the bed allows for the transfer of energy through particle-to-particle collisions, thus enhancing the bed height. As shown in FIG. 10A and FIG. 10B, the non-dimensional bed heights of TiO₂ P25 and P90 increased gradually up to their maximum values of 5 and 7, respectively, when both the vibrational intensities and gas velocities increased. After a gas velocity of 0.02 m/s and a vibrational intensity of 1.6, the non-dimensional height of TiO₂ P25 reached a plateau. The non-dimensional height of TiO₂ P90 powder was higher, suggesting more fluidic behavior than TiO₂ P25 due to its particle properties (see Table 2). To further test the mathematical model that was developed and verify the surface fitting curve, 18 additional sample points, i.e. 9 unique gas velocity/vibrational intensity conditions each for P25 and P90 TiO₂were tested and compared with the 2nd order polynomial model. The nine datapoints were for gas velocities of 0.01, 0.02, 0.03 m/s and the vibrational intensities of 1.3, 1.5, 1.7. The nine data points are shown in FIG. 10A and FIG. 10B and designated with the numbers 1-9. FIG. 11A and FIG. 11B depict the percentage error between the experimental and model predictions of the non-dimensional bed heights for the additional sample points for the two powders. FIG. 11A indicates a less than 14% error between the actual and calculated non dimensional bed heights for TiO₂ P25 and FIG. 11B indicates a less than 7.8% error for TiO₂ P90. The largest error appeared at the experimental condition of large gas velocity (0.03 m/s) coupled with high vibrational intensity (1.7) due to the fluidized bed fluctuation from an excessive support energy from vibration and superficial gas velocity.

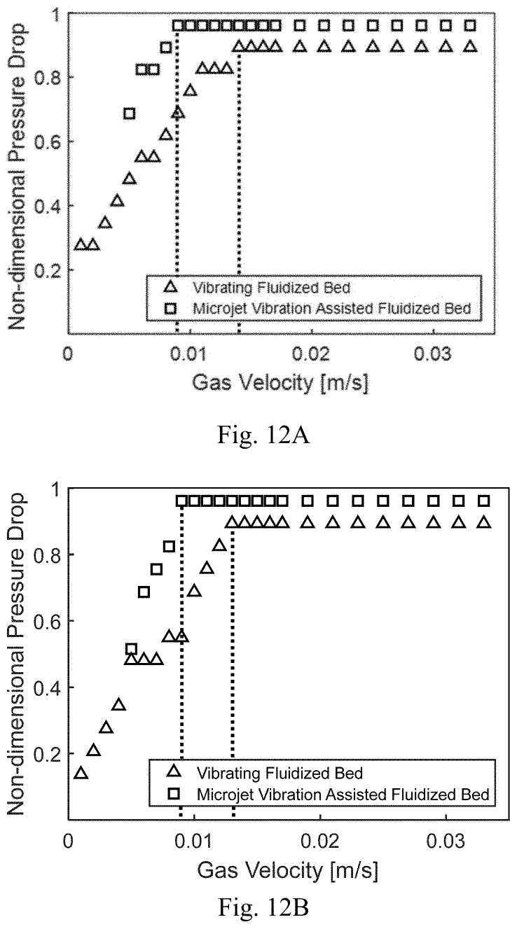

Nondimensional pressure drop can be obtained by dividing the actual measured pressure drop by the apparent weight of the bed. The nondimensional pressure drop parameter (P_{nd}) is useful in indicating whether the gas flow suspends a portion of the powder's mass, and is another measure of the fluidization quality. Pnd was obtained using Equation 4:

$${P}_{n d} = \frac{A Δ P}{mg} \qquad Equation 4$$

Where A (m²) is the cross-sectional area of the column, m is the mass of the powder in kg, g is gravitational acceleration in m/s², and ΔP is the actual measured pressure drop across the fluidized bed in Pa. The non-dimensional pressure drop represents the ratio between the actual pressure drop across the fluidized bed and mass of powder in the reactor. A nondimensional pressure drop close to unity suggests that the flow suspends most of the mass of the powder. The nondimensional pressure drop parameters are shown in FIG. 12A (for TiO₂ P25) and FIG. 12B (for TiO₂ P90), plotted against gas velocities for the VFB and MVA fluidization systems. The figures show that when combined microjet and vibrational assistance are applied, the TiO₂ nanopowders are suspended in the gas phase more than in the VFB system because the measured pressure drop approaches the apparent weight of the powder. The minimum fluidization velocity (U_{mf}) is a key parameter related to the fluidized bed system's quality and can be determined using the data of FIG. 12A and FIG. 12B. For TiO₂ P25 nanopowder, the minimum fluidization velocity (defined as the velocity where the pressure drop becomes constant) of 0.009 m/s for the MVA system is lower than the 0.013 m/s for the VFB system. For TiO₂ P90 nanopowder, a minimum fluidization velocity of 0.009 m/s was obtained for the MVA system (i.e the same value as for the TiO₂ P25). A minimum fluidization value of 0.014 m/s for TiO₂ P90 using the VFB system was slightly higher as compared to when TiO₂ P25 was used. In either case, MVA fluidization resulted in a lower minimum required gas velocity as compared to the VFB system, thus suggesting more efficient and higher quality fluidization.

### Theoretical Considerations

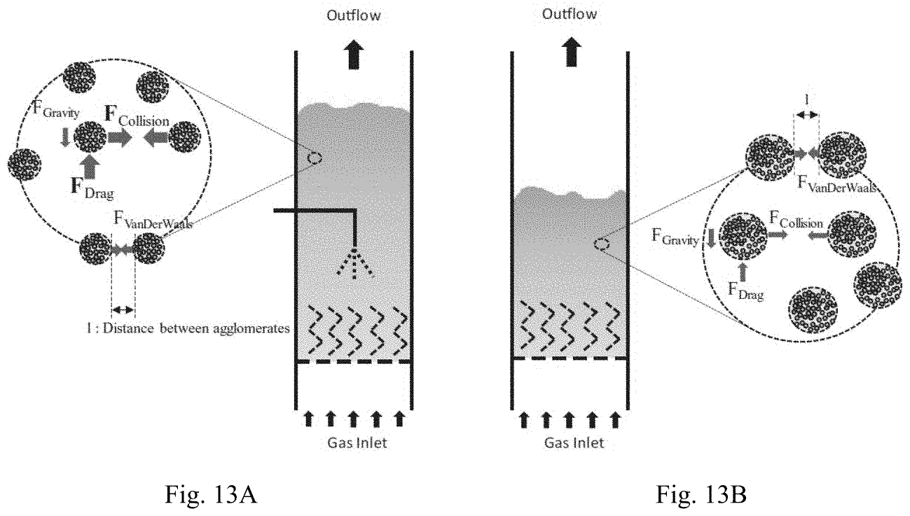

The presented data show the benefits of the MVA system in enhancing the fluidization of nanoparticles by increasing bed expansion. An important consideration is the mechanism associated with this enhancement in bed height. Fabre et al. (Fabre A., Fluidized Nanoparticle Agglomerates Formation, Characterization and Dynamics, PhD thesis Delft University of Technology 2016, incorporated herein by reference) compared the forces as a function of the agglomerate size, showing that the dominant forces acting on the fluidized agglomerate of TiO₂ P25 were Van der Waals and collision. The MVA system likely amplifies the drag and collisional forces on the agglomerates because of the secondary flow that emerges from the micronozzle, thereby leading to highly expanded bed height in the MVA system (e.g. as seen in FIG. 7A). The forces and differences in bed heights in the MVA and VFB systems are depicted in FIG. 13A and FIG. 13B, where the sizes of the arrows in the insets showing the particle forces are meant to suggest the differences in the magnitudes of the forces between the two systems. FIG. 13A shows a schematic of forces acting on agglomerates in a Microjet and Vibration Assisted (MVA) fluidized bed of The MVA system, while FIG. 13B shows a schematic of forces acting on agglomerates Vibrating Fluidized Bed (VFB). Van der Waals is the main force holding the agglomerates together, counteracted by the separation forces that include collisional, drag and gravitational forces. The highly expanded bed height of the MVA system is likely due to the microjet assistance that magnifies the drag and collision forces in the fluidized bed. The MVA system likely contributes to the maintenance of small agglomerate sizes and to the minimization of the effects of electrostatic forces, thereby allowing for expanded bed heights.

### CCS—Setup

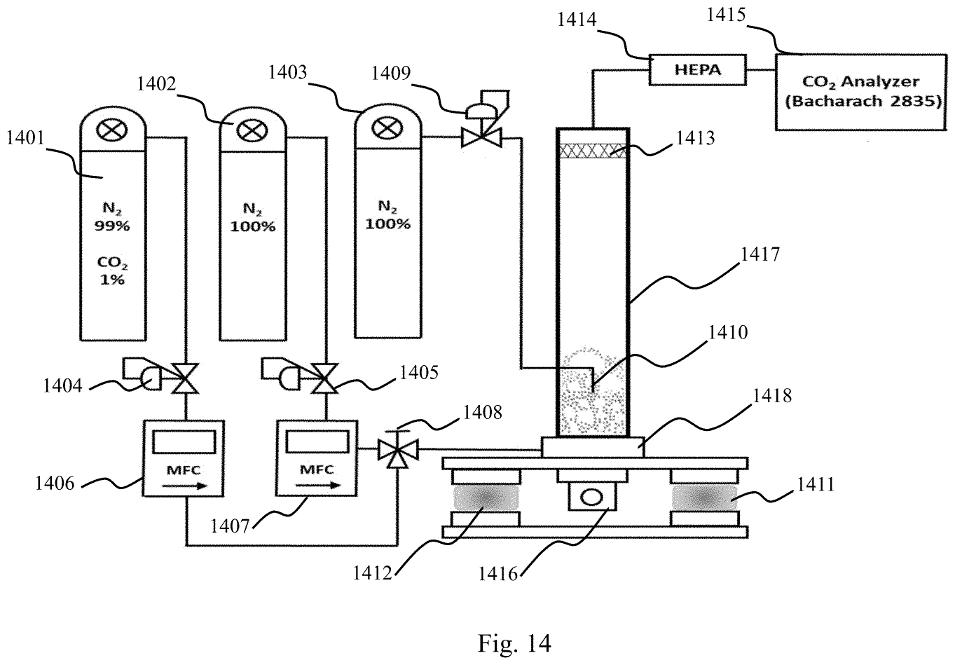

An exemplary system for testing a fluidized bed of the disclosure for use with CCS is shown in FIG. 14. The depicted system includes a compressed gas cylinder comprising 99% N₂ and 1% CO₂ 1401, and two compressed gas cylinders comprising a gas mix of pure N₂ 1402 and 1403. Output from the gas cylinders are controlled by pressure regulating valves 1404, 1405, and 1409, T-type valve 1408, and mass flow controllers 1406 and 1407. Pressure regulating valve 1409 controls the flow of gas from cylinder 1403 through micronozzle or microjet nozzle 1410 into fluidization reactor 1417. The gas from cylinders 1401 and/or 1402 enters the fluidization reactor 1417 through gas distributor 1418. Vibrator 1416 exerts a controlled vibration force on the fluidization reactor 1417, while one or more vibration isolators 1411, 1412 isolate the vibration of the fluidization reactor from the surface on which it is placed. The outlet gas flows through prefilter 1413, HEPA filter 1414, and into a CO₂ analyzer 1415 for measuring the output concentration. The depicted apparatus is configured to test both the CCS capacity of a fluidized bed and a sustainability analysis of such a system. Data was collected using vibration parameters as discussed above, and was compared both with and without the microjet assisted

### CCS—Methods

Several methods exist for capturing carbon dioxide. These include amine-based sorbents, ionic liquid-based sorbents, and zeolites. These methods are fully described in the following publications, which are incorporated herein by reference. M. Songolzadeh, et al., Carbon Dioxide Separation from Flue Gases: A Technological Review Emphasizing Reduction in Greenhouse Gas Emissions, Scientific World Journal Volume 2014, Article ID 828131; and M. Wang, et al., Post-combustion CO₂ capture with chemical absorption: A state-of-the-art review, Chemical Engineering Research and Design 89 (2011) 1609-1624.

### CCS—Results

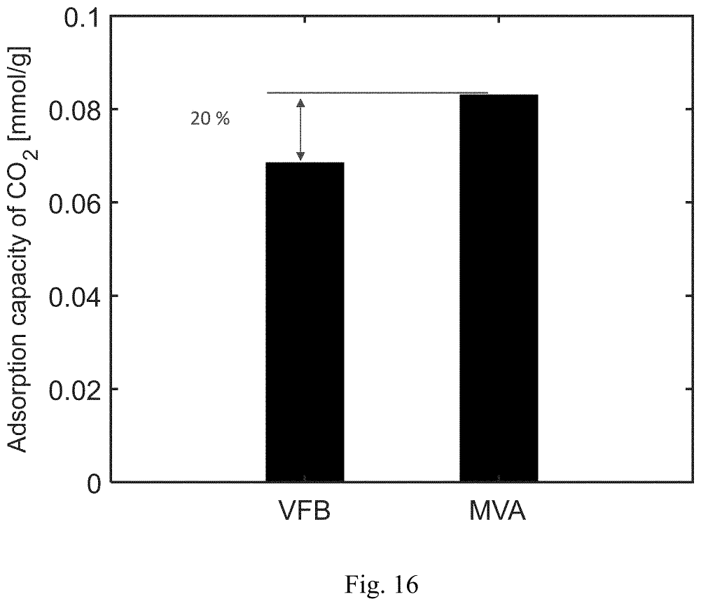

FIG. 15 shows a graph measuring the ratio between the outlet concentration of CO₂ and the inlet concentration of CO₂ over time, comparing results for an MVA fluidized bed and a non-microjet, vibrating fluidized bed (VFB). The breakthrough and maximum adsorption times for the MVA and VFB systems for the given mass of material can be determined from the data that are presented. The breakthrough time is the first time when the bed's adsorption capacity begins to decrease. Beyond breakthrough time, CO₂ continues to be adsorbed within the bed, until the point where saturation of the particles is achieved. The maximum adsorption time refers to the time that is required to reach full saturation of CO₂ onto the nanoparticle surfaces for the given mass of solid sorbent. The breakthrough time of the MVA and VFB systems for the given mass of solid sorbent of 50 g with a fixed superficial gas velocity for both of 0.02 m/s was 0.5 minutes for the MVA and 0.3 minutes for the VFB system. The maximum adsorption time was 1.7 minutes for the MVA system and 1.4 for the VFB system. From the data in FIG. 15, the adsorption capacity may be estimated based on Equations 5 and 6 below

$$\begin{matrix}q = \frac{Q {t}_{s} {C}_{i n}}{22.4 W} & Equation 5 \\ {t}_{s} = {\int }_{0}^{t} ( 1 - \frac{{C}_{out}}{{C}_{i n}} ) dt & Equation 6\end{matrix}$$

where q is the equilibrium adsorption capacity of CO₂ in mmol/g, is is the mean residence time in minutes, Cout is outlet concentration of CO₂, Cᵢₙ is the inlet concentration of CO₂, t is the adsorption time in minutes, Q is the volumetric flow rate in mL/min, and W is the mass of the sorbent in grams. The calculated adsorption capacity is 0.083 mmol/g for the MVA system, which is a significant improvement over the 0.066 mmol/g for the VFB system. This difference in the adsorption capacity is due to the increased fluidization height of the MVA system as compared to the VFB system. A bar graph of adsorption capacity in mmol/g of the MVA and VFB is shown in FIG. 16, indicating a 20% increase in adsorption capacity by the MVA system over the VFB system.

### Conclusions

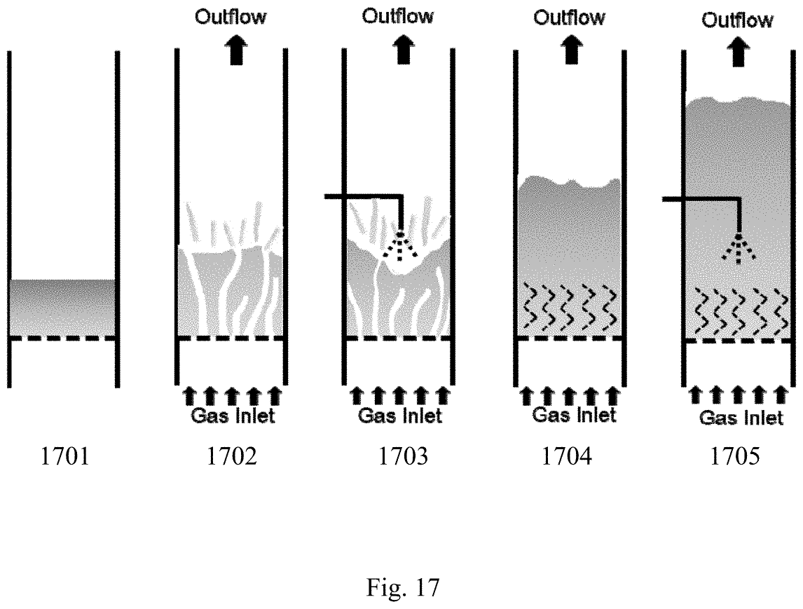

The disclosed experimental examples demonstrate that fluid dynamic characteristics and fluidization quality of microjet and vibration assisted (MVA) fluidization at varying vibration intensities and frequencies produces results superior to simple MA fluidization or a VFB system. Combined MVA fluidization required a relatively low minimum fluidization gas velocity while maintaining a high nondimensional height. A summary of the resulting flow patterns of different bed scenarios that were tested is shown in FIG. 17. Diagram 1701 depicts a packed bed, as a starting point. Diagram 1702 depicts a conventional fluidized bed, using only gas injected from the bottom plate. Diagram 1703 depicts an MA (microjet assisted) bed, with a microjet injecting an additional downward flow of gas. Diagram 1704 depicts a VFB (vibrating fluidized bed) wherein the fluidization reactor is subjected to vibration. Finally diagram 1705 depicts an MVA (microjet and vibration fluidized bed) similar to the system disclosed herein. By using the combined MVA fluidization technique, smooth fluidization of the nanopowders and a conversion of solid-like flow to fluid-like motion was achieved, even in the absence of added chemicals (e.g. an alcohol solution) to minimize particle agglomeration. TiO₂ P25 and TiO₂ P90 nanopowder bed height in the MVA system expanded several times more than in the VFB system and showed smooth fluidization without an alcohol support, even at high superficial gas velocities. The disclosed systems and methods should enable the expanded use of nanoparticle fluidization in applications related to environmental remediation or chemical reaction engineering, where the addition of chemicals is not desirable.

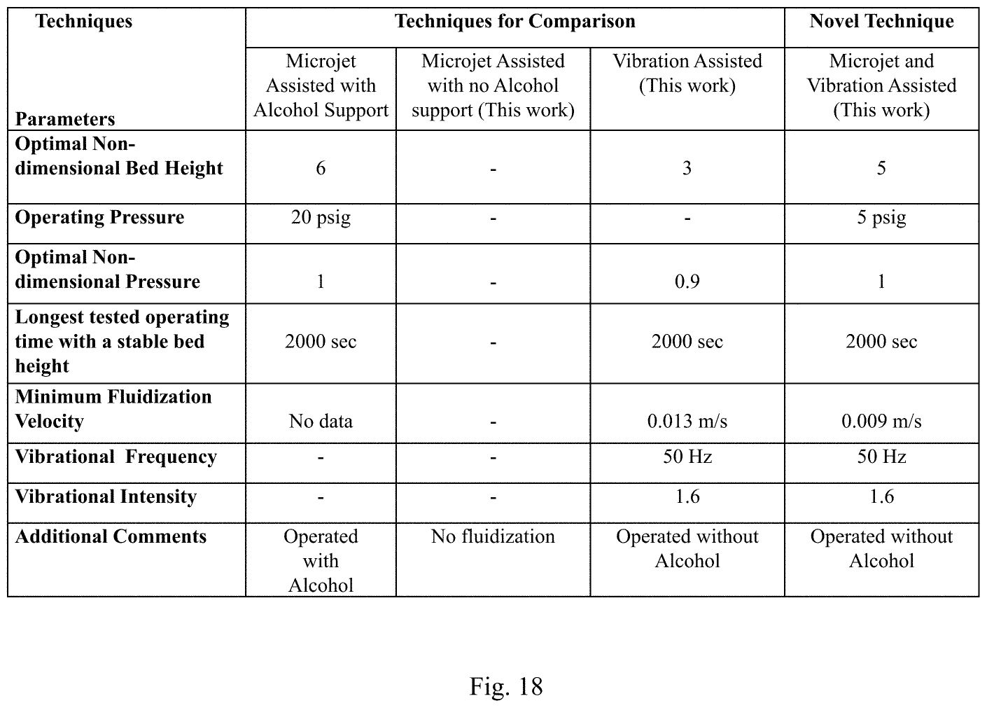

A summary comparison chart of the effectiveness of various fluidization methods is shown in FIG. 18. The results in FIG. 18 relate specifically to a commercially-available TiO₂ P25 nanoparticle powder as discussed above. As shown, the disclosed system and method was comparable in fluidization efficiency to the microjet assisted with alcohol support, but was able to accomplish those results at a lower operating pressure and without the addition of alcohol.

The increased fluidization made possible by the systems and methods disclosed herein leads to increased effectiveness of the system for use in CCS in particular, as explained above.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A system for fluidizing particles, comprising:
a fluidization reactor having a base, a gas injection surface positioned at the base configured to inject a first gas into the fluidization reactor, and a gas outlet;
a secondary gas injector comprising a nozzle, positioned in the fluidization reactor and configured to deliver a secondary flow of a second gas into the fluidization reactor;
a vibration inducing device rigidly attached to the fluidization reactor and configured to induce a vibrational acceleration on the fluidization reactor; and
a vibration isolating device rigidly attached to the fluidization reactor and a mounting surface, configured to isolate vibrational forces from the vibration inducing device from the mounting surface.

2. The system of claim 1, further comprising a controller connected to the vibration inducing device and configured to control at least one vibration parameter of the vibration device selected from the group consisting of vibration intensity, vibration frequency, and axis of displacement.

3. The system of claim 2, further comprising a mass flow controller fluidly connected between the source of first gas and the gas injection surface and communicatively connected to the controller, configured to control the flow of first gas into the gas injection surface.

4. The system of claim 2, further comprising a first pressure regulator fluidly connected to the gas injection surface, and a second pressure regulator fluidly connected to the secondary gas injector, wherein the first and second pressure regulators are communicatively connected to the controller.

5. The system of claim 1, further comprising a fluid bubbler, fluidly connected between a source of first gas and the gas injection surface, wherein the first gas flows through the fluid bubbler, then through the gas injection surface into the fluidization reactor.

6. (canceled)

7. The system of claim 1, wherein the vibration inducing device is configured to vibrate at a frequency in a range of 40 to 70 Hz.

8. The system of claim 1, further comprising a differential pressure sensor having a first tap positioned near a top end of the fluidization reactor and a second tap positioned near the base of the fluidization reactor, configured to measure a differential pressure along a height of the fluidization reactor.

9-11. (canceled)

12. The system of claim 1, wherein the secondary gas injector nozzle has an outlet diameter in a range of 200 to 500 μm.

13. (canceled)

14. The system of claim 1, wherein the secondary gas injector nozzle is configured to inject the second gas in a direction substantially towards the base of the fluidization reactor.

15. The system of claim 1, wherein the first gas comprises CO₂.

16. (canceled)

17. A method of fluidizing a quantity of particles, comprising:
positioning a quantity of particles in a fluidization reactor;
inducing a vibrational force on the fluidization reactor;
injecting a first gas into the fluidization reactor from a gas injection surface positioned at the base of the fluidization reactor; and
injecting a second gas into the fluidization reactor from a secondary gas injector;
wherein the quantity of particles fluidizes to a nondimensional height of at least 2.

18. The method of claim 17, further comprising waiting for a time period of at least one minute after inducing the vibrational force, before injecting the second gas into the fluidization reactor.

19. The method of claim 17, further comprising filtering the first gas or the second gas through a fluid bubbler prior to injection into the fluidization reactor.

20. (canceled)

21. The method of claim 17, further comprising measuring a differential pressure between a first tap at a distance from the base of the fluidization reactor and a second tap near the base of the fluidization reactor.

22-24. (canceled)

25. The method of claim 17, further comprising passing the quantity of particles through a sieve prior to positioning the particles in the fluidization reactor in order to remove agglomerates.

26. The method of claim 17, wherein the particles are TiO₂ particles.

27. The method of claim 17, wherein the first gas is injected at a superficial gas velocity of between 0.005 m/s and 0.035 m/s.

28. The method of claim 17, wherein the vibrational force is induced at a frequency between 40 Hz and 70 Hz.

29. (canceled)

30. The method of claim 17, wherein the first gas is selected from the group consisting of CO₂, N₂, O₂, CH₄, CO, NO, NO₂, and a volatile organic compound.

31. The method of claim 17, wherein the second gas is selected from the group consisting of CO₂, N₂, O₂, CH₄, CO, NO, NO₂, and a volatile organic compound.
